(19) United States
(12) Patent Application Publication
(10) Pub. No.: US 2010/0294204 A1
(43) Pub. Date: Nov. 25, 2010

(54) MEASUREMENT OF ANIMAL TEMPERAMENT

(76) Inventors: José Aurélio Garcia Bergmann, Belo Horizonte (BR); Walsiara Estanislau Maffei, Teixeira de Freitas BA (BR); Marcos Pinotti Barbosa, Belo Horizonte (BR); Alexandre Gonçalves Teixeira, Belo Horizonte (BR)

Correspondence Address: NIXON & VANDERHYE, PC, 901 NORTH GLEBE ROAD, 11TH FLOOR, ARLINGTON, VA, 22203, US

(21) Appl. No.: 12/682,772

(22) PCT Filed: Jul. 8, 2008
(86) PCT No.: PCT/BR08/00198

§ 371 Date: Jul. 21, 2010

(30) Foreign Application Priority Data
Jul. 9, 2007 (BR) PI0705152-2

(51) Int. Cl. A01K 1/03

(52) U.S. Cl. 119/421

(57) ABSTRACT

The present invention is about two methods and three devices for the purpose of measuring the animal temperament by measurement of the confinement reactivity in contention environment in the absence or presence of induced stimulus.

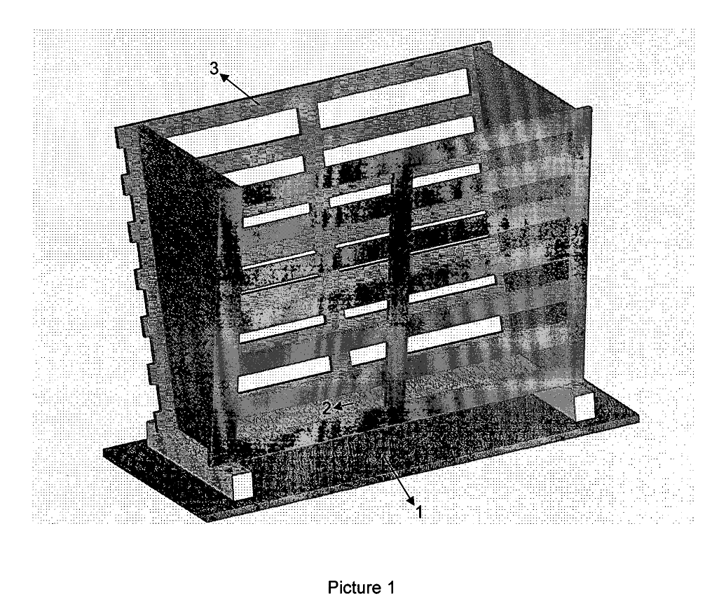

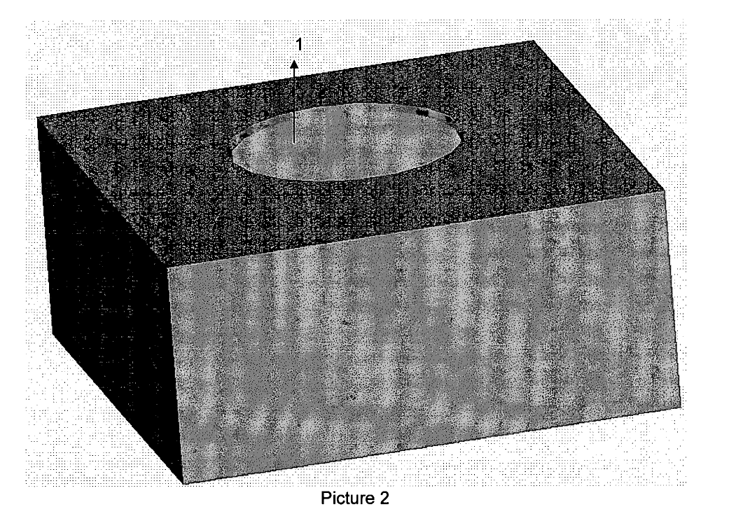

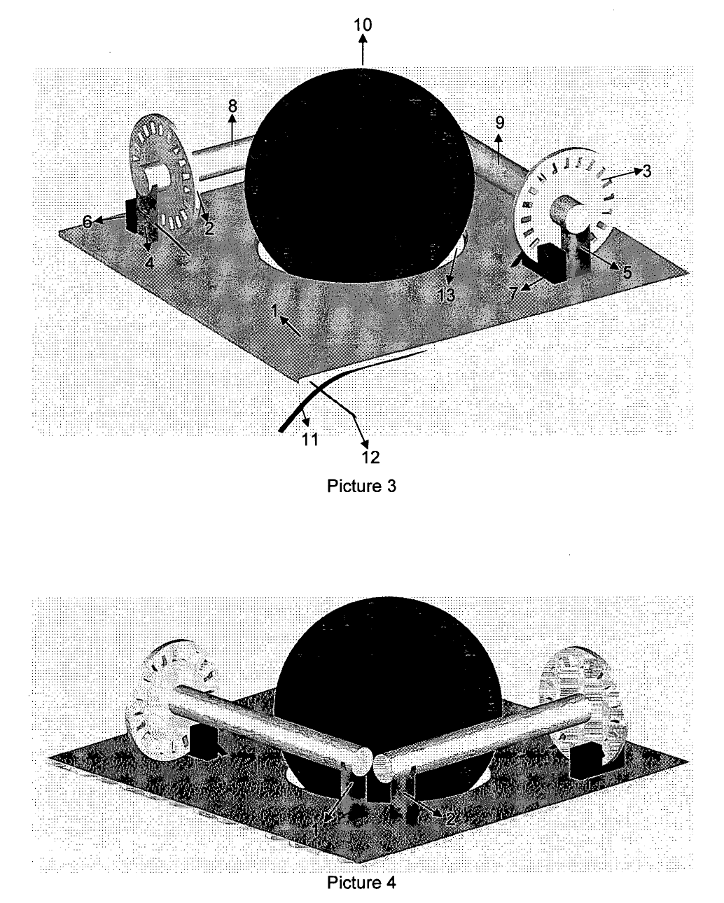

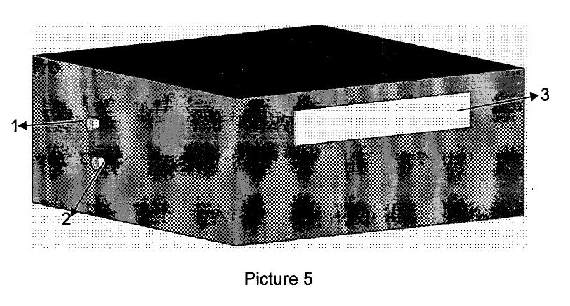

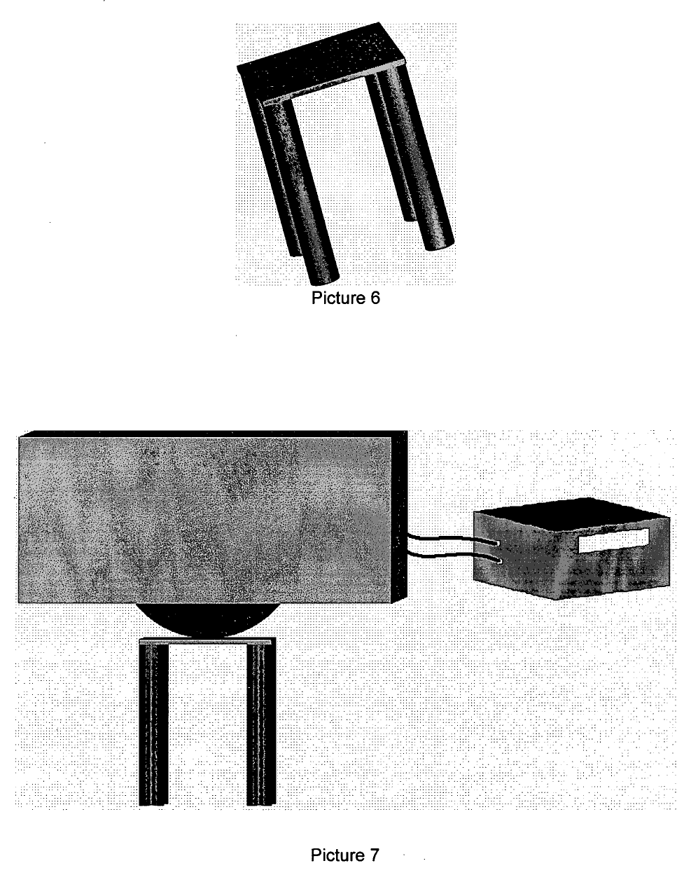

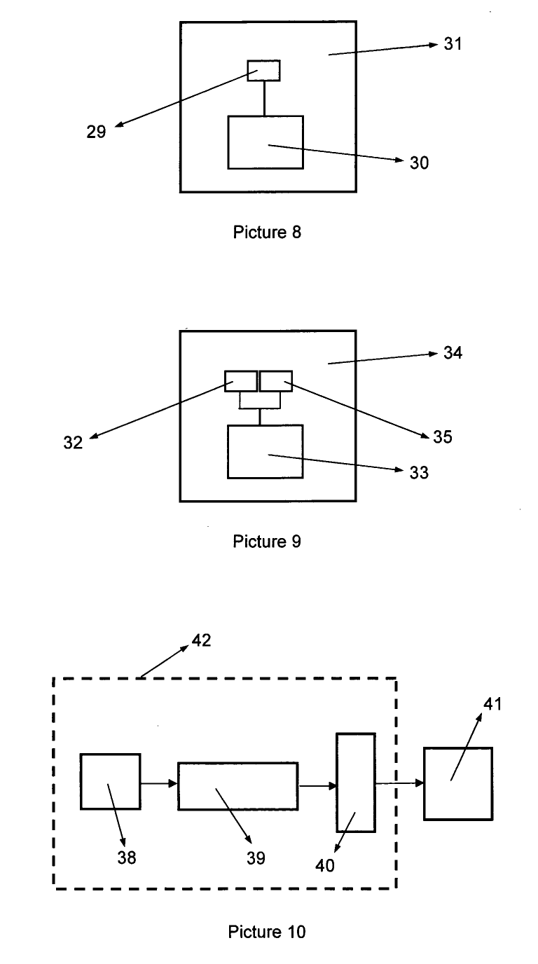

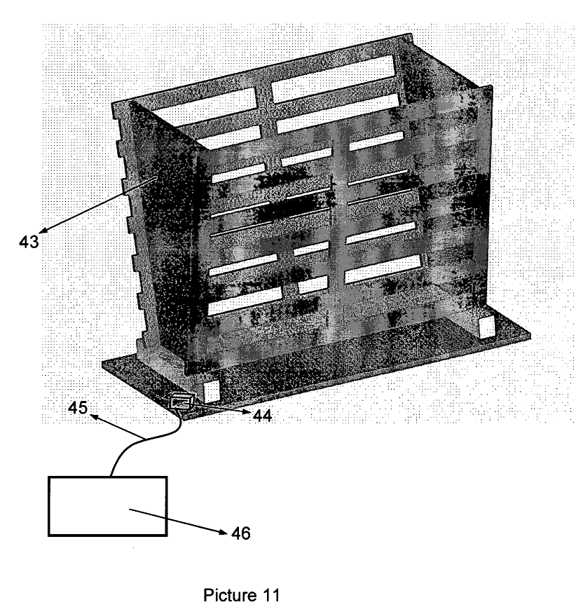

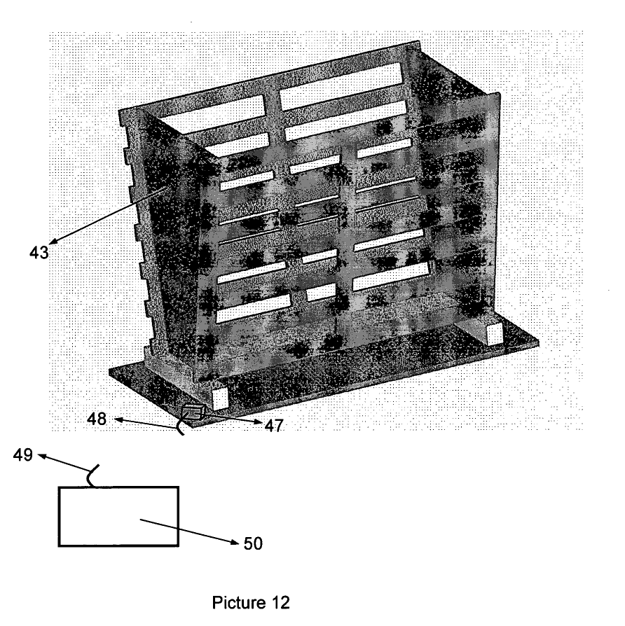

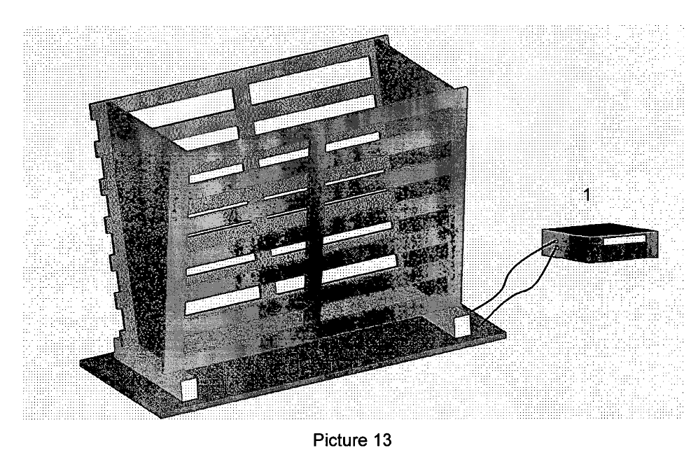

The present invention is about two methods and three devices for the purpose of measuring the animal temperament through the measurement of the animal confinement reactivity measured in contention environment with mobility, in the absence or presence of induced stimulus.

A lot of papers tell about differences in the behavior expression between species and domestic animals breeds. The animal behavior can be influenced by the breed, the bloods lines, the individual genetic variations within the breed and the environment type that the animal is created. The animal temperament is a trait of the animal behavior, and it has great importance in the animal production systems. It is because the animal temperament can affect his development and cause economical losses.

The animal temperament is defined as the expression of fear in response to actions done by man during the daily management activities realized with the animals. This expression can be aggressive or calm. Aggressive animals have bad temperament and bad temperament animal can gain less weight, produce less milk and cause accidents with other animals and personnel, increase maintenance costs of ranch buildings and have worst quality meat and leather. Therefore, high costs and low profit.

Several Methods and devices for animals on diet control were found at technique state. However, patents with the same application as described in the technology object of this invention (measurement of temperament in animal) were not found. Except, the document EP1520471B1, that presents a equipment for animal attendance. It is a stress measurement device.

This equipment is the junction of a infrared meter to obtain animal image; a hygrometer to determine humidity in the animal hair and nose; a smell or odor meter to measure breath and odor in the animal body; an animal muscular tension meter to determine the muscular tension; an equipment to analyze the animal excrement to determine characteristics of this excrement; and a animal muscle vibration meter to determine the animal vibrations.

At present, the few techniques used to quantify the animal temperament and the devices that allow the application are of public domain and it can be separated in subjective and objective.

The subjective techniques don't request any device for application, because it is based in the visual evaluation (qualitative measures). That is, in the technician observation for temperament, when the animal is arrested in contention or closed environment. The measured animals are classified in growing scale of confinement reactivity. The confinement reactivity scale range from 1 to 5 or 7. Smaller values indicates docile temperament, and larger values indicates aggressive temperament.

The objective techniques and objective devices measure the animal temperament in a quantitative way. The objective techniques and objective devices use continuous scales of measurement. Those techniques and devices allow classifying animals in larger amplitude of temperament, besides the objective techniques and objective devices eliminate the subjective effect of technician.

The objective techniques and devices, known and mentioned in the literature, consider the minimum distance of the man's approach tolerated by the animal (escape distance, mentioned, among other, by G. Fordyce et al., Australian Journal Experimental of Agriculture, v. 36, pages 9-17, in 1996), the time spent by the animal when covering certain distance (flight speed, mentioned by H. M. Burrow et al., Proceedings of The Australian Society Animal of Production, v. 17, pages 154-157, in 1998; and H. M. Burrow, Livestock Production Science, v. 70, pages 213-233, in 2001), or even, the position of the hair whirl on the animal's forehead (mentioned, among other, by T. Grandin et al., Applied Animal Behavior Science, v. 46, pages 117-123, in 1995; H. D. Randle, Applied Animal Behavior Science, v. 56, pages 139-147, in 1998; and Lanier et al., Applied Animal Behavior Science, v. 73, pages 93-101, in 2001). All these techniques and devices associated to them were described, specifically, for bovine. The escape distance technique has the inconvenience of exposing the technician to a high accident risk. It is due to the possibility of animal attack, mainly if this technique be used in Bos Taurus Indicus, bovine of Indian origin. The flight speed technique has the inconvenience of being species specific, not being useful to certain species or animal breed. That is due to intrinsic characteristics of this technique.

For instance, the Bos Taurus Indicus animals don't usually move away front the man's approach, they attack him, instead. In a similar way, the position of the hair whirl on the animal's forehead technique is a characteristic of certain species or breed and can't be applied in a widespread way.

Due to existent limitations in the techniques currently used to measure the animal temperament and looking for a risk free, low cost and easy to use method of objective quantification of the animal temperament, the method through the confinement reactivity in contention environment with mobility and the associated devices were developed. Those techniques and devices are the object of the present patent request.

The new methods and devices, here described can be used in several domestic animals species of economical importance, such as bovine, swine, sheep, goats, buffaloes and equine, no restrictive, since these animals are in a contention environment with mobility. This methods and devices are capable of measure the confinement reactivity by mechanical, optical, electronic, magnetic means, or any other appropriate one.

The first method to measure the animal temperament, through the confinement reactivity in contention environment with mobility, is based on the association among the animal temperament and the intensity and the frequency of movements. Those movements are generated by the animal on the contention environment base or contention environment support, when the animal is arrested by certain period of time in this environment with mobility.

The intensity and frequency of the animal movement during the permanence time inside the contention environment with mobility are captured directly from the contention environment base or contention environment support. Animals of aggressive temperament tend to produce movements more intense and more frequent than animals of docile temperament.

The second method for evaluation of the animal temperament, through the confinement reactivity in contention environment with mobility, is also based on the association between the animal movements and his temperament. But, in this case, the environment base is an electronic scale. However, the intensity and frequency of the animal movement during the weighting are not captured directly from the movement of the contention environment base, but from the signal variability generated by the weighting cells of the electronic scale. This variability is used as a parameter of the animal behavior classification. Like this, animals that move a lot on the electronic scale during the weighting, generates larger signal variation in the weighting cells and, consequently, they are classified as more aggressive, on the other hand, animals that move less generates smaller signal variations in the weighting cells and they are classified more docile.

There are two devices associated to the method number 1: Device number 1 and device number 2. The device number 1, Device Based On Optical-Mechanics Sensor For Measurement Of The Animal Temperament Through The Confinament Reactivity In Contention Environment With Mobility, uses a mechanism that quantifies the movement of the contention environment base or contention environment support as a consequence of the animal movement inside this environment. The confinement reactivity points for each animal will be obtained through the analysis of the number of occurrences of the contention environment base movements or contention environment support movements, of the intensity of this movement and, or, temporary variation this movements that will be captured by the device based on optical-mechanics sensor.

Device number 2, Device Based On Acceleration Electronic Sensor For Measurement Of The Animal Temperament Through The Confinament Reactivity In Contention Environment With Mobility, uses a mechanism that quantifies the contention environment base movement, or of the contention environment support movement as a consequence of the movement of the animal inside this environment. The confinement reactivity points for each animal will be obtained through the analysis of the occurrences number of the base movements or the support movements, of the intensity of this movement and/or, its temporary variation. It will be captured by the device using the accelerometer (acceleration electronic sensor).

Associated to the second method is the device number 3, Device Based On The Variability Of The Electronic Scale Signal For Measurement Of The Animal Temperament Through The Confinament Reactivity In Contention Environment With Mobility, When The Contention Environment Base Is Of The Electronic Scale Type. This device is more simple than devices 1 and 2. That is due the fact that device number 3 uses the electronic scale electric signal directly.

The electronic scale cells, used to register the animal weight, substitute the mechanism that is coupled to contention environment base with mobility or support to measure the occurrences number of the base movement, of the intensity of this movement and, or, temporary variation this movement.

The drawings enclosed show the configurations of the number 1, number 2 and number 3 devices, for Measurement Of The Animal Temperament through the confinement reactivity in contention environment with mobility.

Those are the objects of the present patent request:

The pictures 2, 3, 4, 5, 6 and 7 refers to the device number 1.
The pictures 8, 9, 10, 11 and 12 refers to the device number 2.
The picture 13 refers to the device number 3.
The picture 1 is a generic contention environment with movable base.
The picture 2 is the connection unit used to compose and to protect the picture 3 mechanism.

The pictures 3 consists of the quantification mechanism, by optical means, of the reactivity or of the animal movement arrested inside the contention environment (24), here considered as indicative of the animal temperament.

The picture 4 is another perspective of the picture 3.
The picture 5 is the signal processing unit of the animal confinement reactivity.
The picture 6 is the fixed reference table.
The picture 7 is a group vision of the device number 1 for Measurement Of The Animal Temperament through the confinement reactivity in contention environment with mobility
The picture 8 consists of the quantification mechanism, through an accelerometer of two or three axis, of the movement and/or of the animal confinement reactivity in contention environment with mobility (24), here considered as indicative of the animal temperament.
The picture 9 consists of the quantification mechanism of the movement and/or of the animal confinement reactivity in the contention environment with mobility (24), here considered as indicative of the animal temperament, through two accelerometers of one axis.
The picture 10 is the blocks diagram for acquisition, processing and connection with the storage device, and/or processing, and/or data exhibition of the device number 2. It is based on the quantification of the animal confinement reactivity in the contention environment (24), and/or based on the quantification of the movement, through an accelerometer of two or three axis or of two accelerometers of one axis. Here considered as indicative of the animal temperament,
The picture 11 is a group vision of the device number 2 for Measurement Of The Animal Temperament through the animal confinement reactivity in the contention environment with mobility, where the connection between the measure unit and the processing and exhibition of the results is accomplished through cables. The picture 11 represents the way of signals transmission by cables (45) between the measurement device (44) installed in the movable base (23) of the contention environment (43), and the exhibition unit, storage and processing of the transmitted signals (46).
The picture 12 is a group vision of the device number 2 for Measurement Of The Animal Temperament through the animal confinement reactivity in the contention environment with mobility, where the connection between the measure unit and the processing and exhibition of the results is accomplished by wireless method. The picture 12 represents the signal transmission by wireless system between the measurement device (47) equipped with a transmitter/receiver (48) of radio frequency, Bluetooth or similar technology, no restrictive, installed in the movable base (23) of the contention environment (43), and the exhibition unit, storage and processing of the transmitted signals (50) equipped with a transmitter/receiver (49) compatible with the transmitter/receiver of the measurement device (47).
The picture 13 is a group vision of the device number 3 for the case in that the device is used in the contention environment with mobility, of the electronics scale type used for bovine and other species.

### DETAILED DESCRIPTION OF THE INVENTION

According to the introduced in pictures 2, 3, 4, 5, 6 and 7, the device number 1 is constituted by the connection unit, illustrated in the picture 2, used to compose and to protect the mechanism illustrated in the picture 3 and, at the same time, through the hole (1) and of the box (2), to connect the device to the base (23) of the contention environment with mobility (24). The hole (1) can be modified from way to assist specific conditions of the contention environment with mobility (24). The mechanism illustrated in the picture 3 is connected to the box's inferior borders (2) through the base plate (3). This mechanism is constituted by the perforated disks (4) and (5), fastened to the support axis (10) and (11) that are in contact with the base plate (3) through the supports (6), (7), (18) and (19). In contact with the axis (10) and (11) it is the sphere (12). The sphere (12) is also in contact with the reference table illustrated in the picture 6 through the hole (15). The reference table illustrated in the picture 6 is maintained with fixed reference (23) in relation to the movable environment (25), in which the animal is arrested. The animal confinement reactivity signal is processed in the processing unit of the picture 4 and the device group is illustrated in the picture 6.

The operation principle of the device number 1 is based on the fact that when the animal is moving in the contention environment with mobility (25), the sphere (12) rotates around its axis due to the fact of it is in contact with the connection unit of the picture 2, that it is moved with the animal movement, and in contact with the reference table of the picture 6, hold the reference base (23). The sphere turn (12) does that the axis (10) and (11) to moved and, together with them, the perforated disks (4) and (5). The perforated disks (4) and (5) when they move they generate patterns that range “0” (zero) and “1” (one) for the optical sensor (8) and (9). The optical sensors (8) and (9) send logical signals for the processing unit of the picture 5 through the wires (13) and (14) that are connected to the entrances (20) and (21). The logical signals are equal to “0” (zero) when the disk solid area (16) is between the transmitter and the receiver of the optical sensor, and 1 (one) when the disk hole (17) is between the transmitter and the receiver of the optical sensor. The logical signals (pulses) sended are counted by the processing unit of the illustration 5 during the sampling time of the confinement reactivity. The total pulses count is used as parameter to evaluate the animal confinement reactivity in the contention environment with mobility. The visualization of the quantification of the animal confinement reactivity is made by the viewfinder (22). besides the entrances (20) and (21), and of the viewfinder (22), the processing unit of the picture 5 is constituted of a logical unit just as a microcontroller, a microprocessor, a dsp or any type of logical unit capable to recognize the optical sensor patterns and to process its counting or variations on this counting through the sampling time.

According to the picture 8, the device number 2 is constituted of a box (31), hermetic or no, of metal, plastic, wood, or other material, no restrictive, that has an accelerometer (29) inside, capable to measure acceleration in two or three axis in the same time, and a circuitry (30) responsible for the acquisition, conditioning and processing of the signal (that came from the accelerometer), and the signal transmission. The device number 2 operation is optimized when it is connected to the movable base of the contention environment (23) in a way that the plan formed by two axis of acceleration measurement is perpendicular to the gravity acceleration vector.

If it is not possible to use an accelerometer of two or of three axis, the device number 2 can be constituted by two accelerometers that measure in one axis. The device using this configuration is shown in the picture 9. This device is constituted of a box (34), hermetic or no, of metal, plastic, wood, or other material, no restrictive, that has two accelerometers inside, and one of them measures the acceleration in a direction (32) and the other one, measures the acceleration in a perpendicular direction that the number one sensor is measuring (35). The accelerometers measure the movement acceleration at the same time, and the circuitry (33) is responsible for the acquisition, conditioning and processing of the signals coming from the accelerometers. The circuitry (33) is responsible for the transmission of the resulting signal too. The operation of the device number 2 is optimized when the accelerometer is connected to the movable base of the contention environment (23) in a way that the plan formed by the two axis of acceleration measurement is perpendicular to the gravity acceleration vector. The measurement unit (42) is connected to the movable base of the contention environment (23) and it has the sensitive unit (38), that can be optical and, or, electronic; the conditioning unit and processing unit of the signal (it comes from of the sensitive element); and the transmission unit of the signal (40) that was modified by the conditioning and processing. The exhibition unit, storage unit and processing unit of the transmitted signals (41) are installed at a place different of the movable base (23).

The acquired signal of the optical sensor or accelerometer, in the present and previous time of the measurement, for each measurement axis, can be codified. The codification is accomplished when the confinement reactivity signals, obtained by the method of the module of the differences on each axis, are used to calculate the instantaneous confinement reactivity (ICR). The ICR is the square root of the sum of the squared differences of the reactivity in present and previous time of measurement. According to the following equation:

ICR=\sqrt{(Xₜ−Xₜ₋₁)²+(Yₜ−Xₜ₋₁)²}

Where X and Y are the measured signals in the perpendicular directions and subscript t means the signal obtained in the present time and the subscript t−1 means the signal obtained in the previous time. This processing incorporates the movement of the movable base of the contention environment in the perpendicular plan to the gravity acceleration vector. To obtain the confinement reactivity (CR) value of each animal, the values of the instantaneous confinement reactivity are accumulated over a fixed time.

The confinement reactivity distribution curve of each lot, group or population of animals can be obtained normalizing the individual confinement reactivity value (CR) in function of the maximum confinement reactivity value (CRmax) and of minimum confinement reactivity (CRmin) of the population, lot or animal group. The normalization is obtained using the following equation:

$$NCR = \frac{10 \cdot ( CR - {CR}_{min} )}{( {CR}_{max} - {CR}_{min} - 1 )}$$

After the reactivity data normalization is possible to obtain a histogram to show the confinement reactivity distribution of the population or of animal lot. With this data is possible to classify the individuals in confinement reactivity categories.

When the contention environment with mobility used for animal weighting is of the electronic scale type, the electronic signal generated by the mechanism (2) is substituted by the signal emitted by the cells (27) and (28), or for any other number of cells, used to register the animal weight in the electronic scale of the picture 13. This signal is sent to the processing unit (26) and its variability is used then as parameter of measurement of the animal confinement reactivity in the electronic scale, here considered as indicative of the animal temperament.

1. Measurement of animal temperament having the following characteristics: a) Methods and devices with the purpose of measuring the animal temperament; b) Confinement reactivity quantification in contention environment with mobility; c) In absence or presence of induced stimulus; or d) Used in several domestic animal species of economical importance;

2. Measurement of animal temperament according to claim 1, wherein the animal is arrested inside the contention environment with a movable base or movable support, capable of being measured by mechanical, optical, electronic, magnetic means or any other appropriate way.

3. A method of measuring animal temperament according to claim 1, the method comprising association among the animal temperament and the intensity and the frequency of movements generated by the animal on the base or support of the contention environment, when arrested by certain period of time in an environment with mobility.

4. The method according to claim 3, characterized by the stage in which intensity and frequency of the movement are acquired directly from the movement of the contention environment base or contention environment support with mobility.

5. A method of measuring animal temperament according to claim 1, the method comprising the association between animal movement on an electronic scale and the animal temperament.

6. The method according to claim 5, characterized by the stage in which intensity and frequency of the movement are acquired from signal variability generated by weighing cells of the electronic scale.

7. The method according to claim 6, characterized by using the signal variability as a parameter of animal behavior classification.

8. The method according to claim 3, characterized by the association of two devices to the first method.

9. A device for measuring animal temperament according to claim 1, the device comprising an optical-mechanical sensor for measurement the temperament in animal through confinement reactivity in contention environment with mobility.

10. The device according to claim 9, characterized by having a mechanism able to quantify the base or support movement of the contention environment.

11. The device according to claim 9, characterized by using the analysis of the environment base or environment support movement, specifically its frequency and number of occurrences or the temporary variation of this movement, acquired by a device based on an optical mechanical sensor as the parameter to obtain the animal reactivity level.

12. The device according to claim 9, characterized by being the principle of operation of the device based on the fact that when the animal is moving inside the contention environment with mobility, the sphere rotates around its axis in contact with the connection unit, that is moved with the animal movement, in contact with the reference table, attached to the reference axis.

13. The device according to claim 11, characterized by the movement of the perforated disks follows the sphere turn, wherein when the sphere moves, it makes the axis move also, and when the perforated disks move they generate ‘0’/‘1’ patterns for the optical sensor, which sends logical signals for the processing unit through the wires that are connected to the inputs.

14. The device according to claim 11, characterized by the logical signal (pulses) sending to the processing unit.

15. The device according to claim 14, characterized by using the total sum of pulses during the sampling time or its temporary variation as parameter to evaluate the animal confinement reactivity in contention environment with mobility.

16. The device according to claim 14, characterized by the processing unit as a logical unit capable to recognize the optical sensor patterns and to process the counting or variations of this counting over a sampling time.

17. The device according to claim 16, characterized by the logical unit being a microcontroller, a microprocessor or a digital signal processor.

18. A device for measuring animal temperament according to claim 1, the device comprising an accelerometer (acceleration electronic sensor) capable of measuring the animal temperament through the confinement reactivity in contention environment with mobility.

19. The device according to claim 18, which is a box, hermetic or no, of metal, plastic, wood, or other material having one or two accelerometers inside, capable of measuring the acceleration in two perpendicular axis at the same time, wherein inside the box there is a circuitry responsible for the acquisition, the conditioning and the processing of the signals (that came from the accelerometer) and, for the transmission of the resulting signal.

20. The device according to claim 18, characterized by being a mechanism capable of quantifying the base movement or the movement support of the contention environment as a consequence of the animal movement inside this environment.

21. The device according to claim 20, characterized by using the analysis of the environment base or environment movable support movement, based on its number of occurrences, intensity, frequency and temporary variation as the parameter to obtain the animal reactivity level.

22. The device according to claim 18, characterized as the connection among the measure unit, the processing unit, and the results exhibition unit being accomplished, optionally, through cables.

23. The device according to claim 18, characterized by wireless signal transmission and equipped with a transmitter/receiver of radio frequency, Bluetooth or similar technology, no restrictive, installed in the movable base of the contention environment, and the exhibition unit, storage and processing of the signals equipped with a compatible transmitter/receiver.

24. A device for measuring animal temperament according to claim 1, the device comprising an electronics scale in which the variability of the electronic scale signal to measure the animal temperament through confinement reactivity in contention environment with movable base.

25. The device according to claim 24, characterized by using the electric signal generated by the electronic scale, the electronic scale cells are used to register the animal weight.

26. The device according to claim 24, characterized by containing a quantification mechanism, that is accomplished through an accelerometer of two or of three axis, the movement and/or of the animal confinement reactivity in contention environment with mobility.

27. The device according to claim 26, characterized by accomplishing the acceleration measurement in two perpendicular axis at the same time.

28. The device according to claim 24, characterized by the measurement unit being connected to the movable base of the contention environment which has the sensitive unit that can be optical or electronics.

29. The device according to claim 28, characterized by the codification of the signal obtained by the sensitive unit.

30. The device according to claim 28, characterized by the codification being accomplished through the animal confinement reactivity signal using the method of the modulus of the differences by axis.

31. The device according to claim 28, characterized by the processing incorporates the movement of the movable base of the contention environment in the perpendicular plan to the gravity acceleration vector.

32. The device according to claim 28, characterized by the substitution of the electronic signal generated by the mechanism by the signal emitted by the electronic scale cells used to register the animal weight in the electronic scale, when the movable base of the contention environment, used for weighing of animals, is of the electronic scale type.

33. The device according to claim 28, characterized by the signal being sent to the processing unit and signal variability is used as a measurement parameter of the animal confinement reactivity in the electronic scale.

34. A method of measuring animal temperament according to claim 1, the method comprising obtaining the confinement reactivity value for each animal, through the accumulation of the instantaneous reactivity values over a given time.

35. The method according to claim 34, characterized by calculating normalized confinement reactivity to obtain a histogram and it shows the confinement reactivity distribution of the population of the animals or of a group of animals.

36. The method according to claim 34, characterized by organizing individuals of the population or the lot of interest in confinement reactivity categories.
